(19) United States
(12) Patent Application Publication
(10) Pub. No.: US 2006/0238467 A1
(43) Pub. Date: Oct. 26, 2006

(54) Full-color light-emitting diode scanning display

(76) Inventors: Chien Chen Hung, Hsinchu (TW); Huai Ku Chung, Hsinchu (TW); Chih Hung Chuang, Hsinchu (TW); Cheng Wei Yang, Hsinchu (TW); Shun Lih Tu, Hsinchu (TW); Hung Tung Wang, Hsinchu (TW)

Correspondence Address: LIN & ASSOCIATES INTELLECTUAL PROPERTY, P.O. BOX 2339, SARATOGA, CA, 95070-0339, US

(21) Appl. No.: 11/114,551

(22) Filed: Apr. 26, 2005

(51) Int. Cl. G09G 3/32

(52) U.S. Cl. 345/83

(57) ABSTRACT

A full-color scanning-type LED display is provided, including a scanning LED module, a projection screen and a structure frame. The scanning LED module further includes a red LED row having a plurality of red LEDs, a green LED row having a plurality of green LEDs, a blue LED row having a plurality of blue LEDs, a driver for driving the red, green, and blue LED rows, a plurality of metal conductive lines for connecting these elements of the scanning LED module, and a micro lens structure for focusing and projecting the light emitted from the red, green and blue LED rows. The driver further includes a driving IC and a serving motor. The projection screen is placed at an appropriate distance from scanning LED module, and both are engaged at the fixed distance by the structure frame.

### FIELD OF THE INVENTION

The present invention generally relates to a full-color small-scaled display made of light-emitting diodes (LED), and more specifically to a full-color scanner-type display with a rotating module of LED array for projecting images onto a screen.

### BACKGROUND OF THE INVENTION

The rapid development of liquid crystal display (LCD) has widely replaced the conventional CRT-based PC monitors. As the size of LCD is considerably much less than the CRT-based monitors, they are used as the notebook PC screens. Although LCD display has the advantages of being low in radiation, it still has the problems of limited viewing angle, heavy weight, and high power-consumption. Numerous researches have been conducted to alleviate the limitation, while alternative displays are been sought for.

On the other hand, the light-emitting diode (LED) arrays are also widely used in many devices or equipments, such as the light source of a copier, a scanner or a printer. FIG. 1 shows a printer using LED array as the light source of the print head. A PCB 10 includes a driver IC 11 driving an LED array 12. A plurality of Au wires 13 are used connected driver IC and LED array 12, and PCB 10. In addition, various types of LED array displays are developed and used on numerous occasions, including traffic signs, outdoor commercial display, and so on. However, LED has not been used in the implementation of PC monitors. In the last decade, the quality and the choice of colors are constantly improving while the manufacturing cost is reducing. The LED should be a good candidate for developing the alternative PC monitors.

### SUMMARY OF THE INVENTION

The primary object of the present invention is to provide a full-color scanning-type LED display. The present invention uses a rotating LED module that is able to scan a full-screen of image and projects the image onto a screen placed at a suitable distance in a line-by-line manner. Based on the theory of persistence of vision, the projected line-by-line image will be seen as a full-screen image. The present invention of a full-color scanner-type LED display includes a scanning LED module, a projection screen and a structure frame.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a conventional LED print head used in a printer;

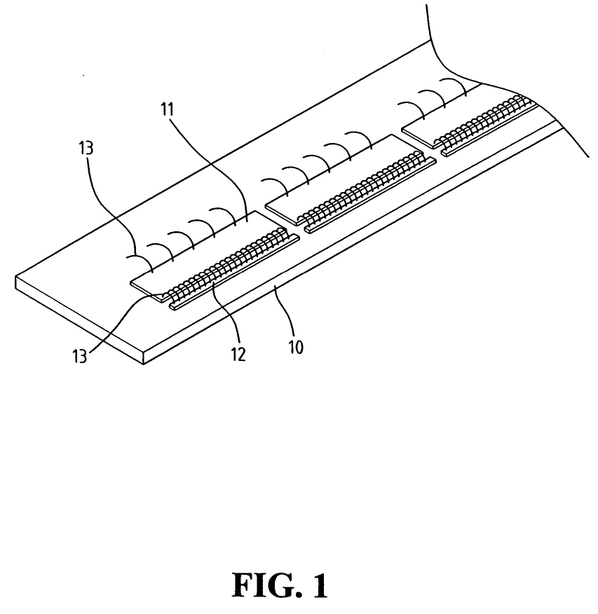

FIG. 2 shows a schematic view of a full-color scanning-type LED display according to the invention;

FIG. 3 shows a schematic view of the present invention used with a notebook PC;

FIG. 4 shows the projection of a line of an image onto a screen;

FIG. 5A shows a schematic view of the arrangement of the LED rows in the scanning LED module of the present invention;

FIG. 5B shows an enlarged view of each dot including three colors of LED; and

FIG. 6 shows a schematic view of the rotating LED rows and the micro lens structure of the scanning LED module of the present invention.

### DETAILED DESCRIPTION OF THE PREFERRED EMBODIMENTS

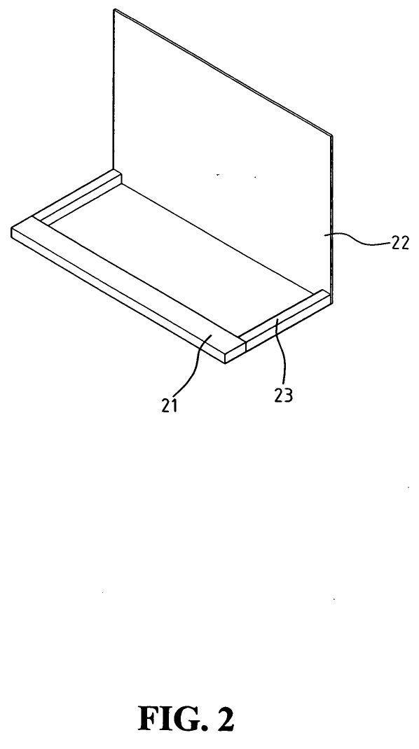

FIG. 2 shows a schematic view of a fill-color scanning-type LED display of the present invention, including a scanning LED module 21, a projection screen 22 and a structure frame 23. Scanning LED module 21 further includes a red LED row having a plurality of red LEDs, a green LED row having a plurality of green LEDs, a blue LED row having a plurality of blue LEDs, a driver for driving the red, green, and blue LED rows, a plurality of metal conductive lines for connecting these elements of the scanning LED module, and a micro lens array for focusing and projecting the light emitted from the red, green and blue LED rows. The driver further includes a driving IC and a serving motor. As shown in FIG. 2, projection screen 22 is placed at an appropriate distance from scanning LED module 21, and both are engaged at the fixed distance by structure frame 23.

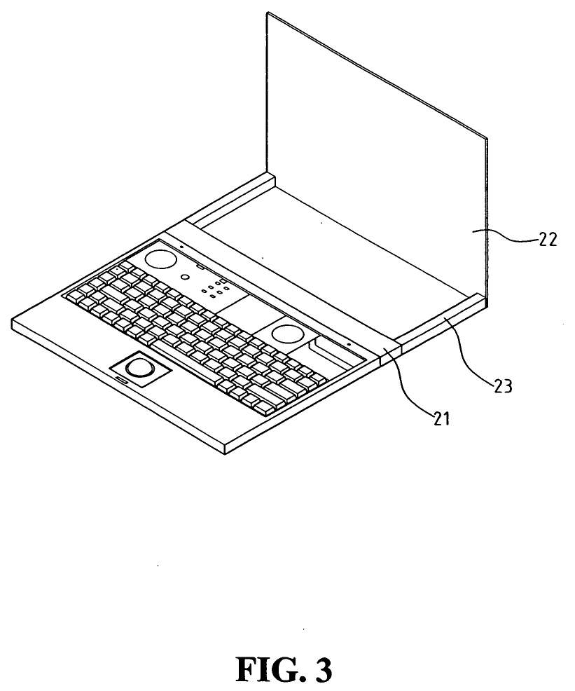

FIG. 3 shows a schematic view of the present invention used as a screen for a notebook PC. As in FIG. 3, scanning LED module 21 is attached to the notebook PC to serve as the display as the conventional LCD display.

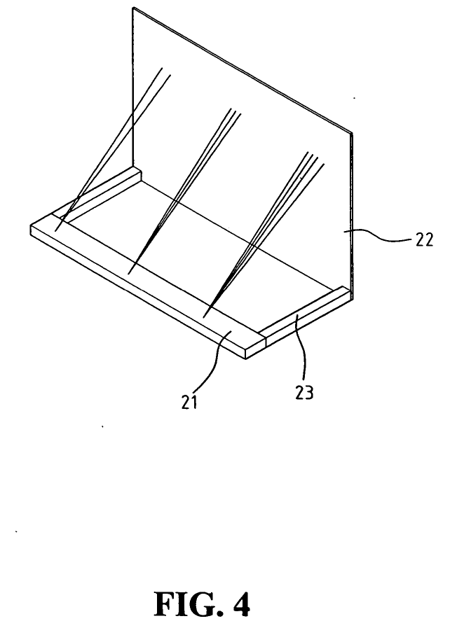

FIG. 4 shows a schematic view of a snapshot of the scanning LED module projecting a line of image on to the projection screen according to the present invention. Based on the theory of persistence of vision, the line-by-line projection of an image will constitute a full-screen image output by the notebook PC if the rotating speed of the scanning LED module is sufficiently fast. For example, a 14-inch LCD screen of a notebook PC is 287.02 mm wide and 215.90 mm high, and is 1024×768 dots in resolution. In other words, by using the scanning LED module of the present invention to scan the height of the screen, the distance between adjacent dots is 280 um, with each dot consisting of a red LED, a blue LED and a green LED. If the persistence of vision is 34 frames per second, the required scanning speed is 26112 (=768×34) times per second.

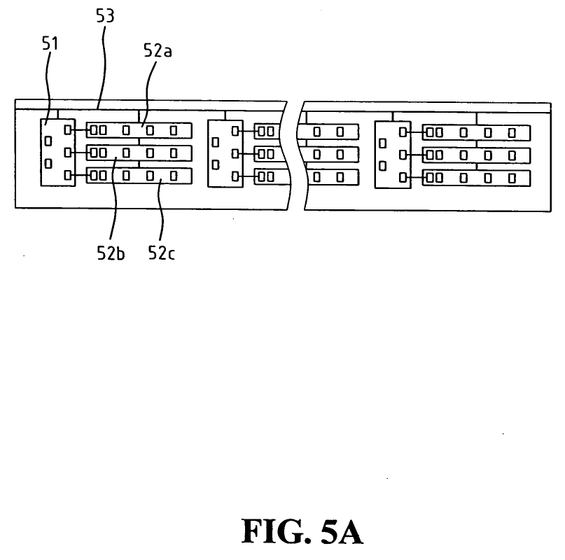

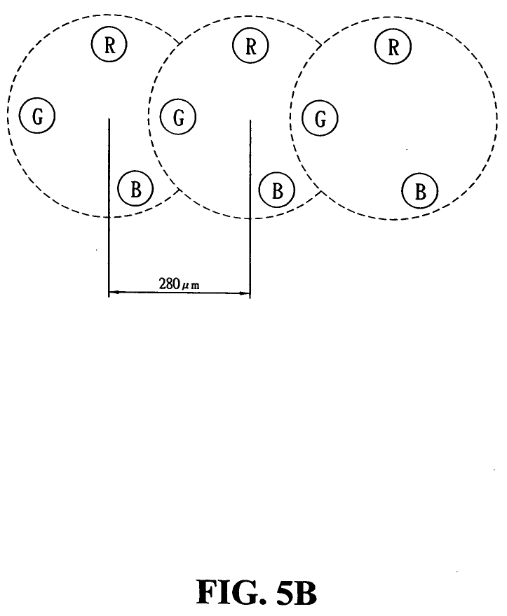

FIG. 5A shows a schematic view of the arrangement of the LED rows in the scanning LED module of the present invention. As shown in FIG. 5A, a driving IC 51 is used to provide control signals, pulses or currency, to a red LED row 52a, a green LED row 52b and a blue LED row 52c, which are connected by a plurality of metal lines 53. For the convenience of manufacturing, all the components can be mounted on a single PCB. A plurality of such arrangements can be used to realize a line of image.

FIG. 5B shows an enlarged view of each dot in FIG. 5A. As shown in FIG. 5B, each dot includes a red LED, a blue LED and a green LED. The distance between the center of neighboring dot is 280 um in this embodiment.

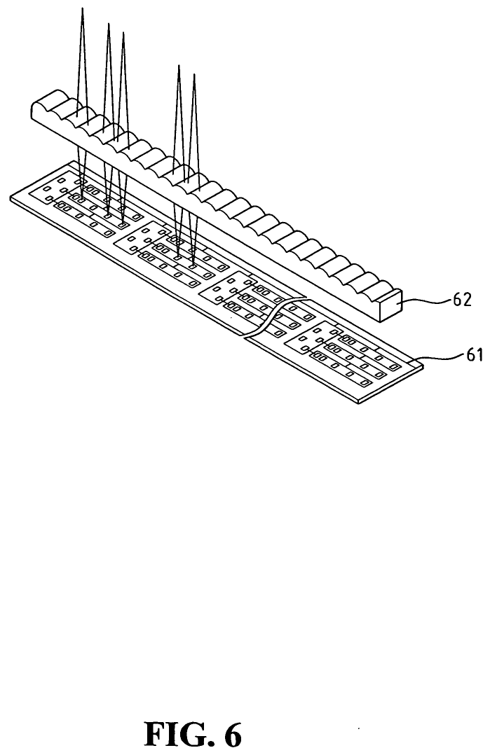

FIG. 6 shows a schematic view of the relative position of LED rows 61 and a micro-lens structure 62. A serving motor is used to rotate LED rows 61, and micro lens structure 62 is positioned to in front of rotating LED rows 61 to focus and project the light from the LEDs onto the screen shown in FIG. 2.

In addition to the aforementioned embodiment of the present invention as a screen for a notebook PC, the present invention can also be used in other equipments appliances, such as a DVD player, and so on.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A full-color scanning-type LED display, comprising:
a scanning LED module; further comprising:
a red LED row having a plurality of red LEDs;
a green LED row having a plurality of green LEDs;
a blue LED row having a plurality of blue LEDs;
a driver having a driving IC for transmitting control signals to said red, green and blue LED rows, and a serving motor for rotating said scanning LED module;
a plurality of metal conductive lines for connecting said LED rows and said driver of said scanning LED module; and
a micro lens structure for focusing and projecting the light emitted from said red, green and blue LED rows;
a projection screen onto which said micro lens structure of said scanning LED module projecting light; and
a structure frame;
wherein said projection screen is placed at an appropriate distance from said scanning LED module, and both are engaged at the fixed distance by said structure frame.

2. The display as claimed in claim 1, wherein said serving motor rotates said scanning LED module to project an image on said projection screen at a speed sufficiently fast so that a full-screen image can be formed based on the theory of persistence of vision.

3. The display as claimed in claim 1, wherein one said red LED, one said green LED and one said blue LED constitute a dot, which are controlled by said driving IC to display a dot of said image.
